(19) United States
(12) Patent Application Publication
(10) Pub. No.: US 2019/0279613 A1
(43) Pub. Date: Sep. 12, 2019

(54) DIALECT AND LANGUAGE RECOGNITION FOR SPEECH DETECTION IN VEHICLES

(71) Applicant: Ford Global Technologies, LLC, Dearborn, MI (US)

(72) Inventors: Joshua Wheeler, Trenton, MI (US); Ahmed Abotabl, San Diego, CA (US); Scott Andrew Amman, Milford, MI (US); John Edward Huber, Novi, MI (US); Leah N. Busch, Berkley, MI (US); Ranjani Rangarajan, Farmington Hills, MI (US)

(21) Appl. No.: 15/913,507

(22) Filed: Mar. 6, 2018

(51) Int. Cl. G10L 15/187; G10L 15/16; G10L 15/30; G10L 15/22; G10L 15/02; G10L 15/00; G06F 3/0488

(52) U.S. Cl. CPC G10L 15/187; G10L 15/16; G10L 15/30; G10L 15/22; G10L 2015/223; G10L 15/005; G06F 3/04886; G10L 2015/025; G10L 15/02

(57) ABSTRACT

Method and apparatus are disclosed for dialect and language recognition for speech detection in vehicles. An example vehicle includes a microphone, a communication module, memory storing acoustic models for speech recognition, and a controller. The controller is to collect an audio signal that includes a voice command and identify a dialect of the voice command by applying the audio signal to a deep neural network. The controller also is to download, upon determining the dialect does not correspond with any of the acoustic models, a selected acoustic model for the dialect from a remote server via the communication module.

### TECHNICAL FIELD

The present disclosure generally relates to speech detection and, more specifically, to dialect and language recognition for speech detection in vehicles.

### BACKGROUND

Typically, vehicles include a plurality of features and/or functions that are controlled by an operator (e.g., a driver). Oftentimes, a vehicle includes a plurality of input devices to enable the operator to control the vehicle features and/or functions. For instance, a vehicle may include button(s), control knob(s), instrument panel(s), touchscreen(s), and/or touchpad(s) that enable the operator to control the vehicle features and/or functions. Further, in some instances, a vehicle includes a communication platform that communicatively couples to mobile device(s) located within the vehicle to enable the operator and/or another occupant to interact with the vehicle features and/or functions via the mobile device(s).

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for dialect and language recognition for speech detection in vehicles. An example disclosed vehicle includes a microphone, a communication module, memory storing acoustic models for speech recognition, and a controller. The controller is to collect an audio signal that includes a voice command and identify a dialect of the voice command by applying the audio signal to a deep neural network. The controller also is to download, upon determining the dialect does not correspond with any of the acoustic models, a selected acoustic model for the dialect from a remote server via the communication module.

In some examples, the selected acoustic model includes an algorithm that is configured to identify one or more phonemes of the dialect within the audio signal. In such examples, the one or more phonemes are unique sounds of speech. In some examples, upon the controller downloading the selected acoustic model from the remote server, the memory is configured to store the selected acoustic model and the controller is configured to utilize the selected acoustic model for the speech recognition. In some examples, the controller is to retrieve the selected acoustic model from the memory upon determining that the acoustic models stored in the memory include the selected acoustic model. In some examples, to identify the voice command, the controller applies the speech recognition to the audio signal utilizing the selected acoustic model.

In some examples, the memory further stores language models for the speech recognition. In some such examples, the controller is to identify a language of the voice command by applying the audio signal to the deep neural network and download, upon determining that the language does not correspond with any of the language models store in the memory, a selected language model for the language from the remote server via the communication module. In some such examples, upon the controller downloading the selected language model from the remote server, the memory is configured to store the selected language model and the controller is configured to utilize the selected language model for the speech recognition. Further, in some such examples, the controller is to retrieve the selected language model from the memory upon determining that the language models stored in the memory include the selected language model. In some examples, a selected language model includes an algorithm that is configured to identify one or more words within the audio signal by determining word probability distributions based on or more phonemes identified by the selected acoustic model. In some examples, to identify the voice command, the controller applies the speech recognition to the audio signal utilizing a selected language model.

Some examples further include a display that presents information in at least one of a language and the dialect of the voice command upon the controller identifying the language and the dialect of the voice command. In some such examples, the display includes a touchscreen that is configured to present a digital keyboard. In such examples, the controller selects the digital keyboard based upon at least one of the language and the dialect of the voice command. Some examples further include radio preset buttons. In such examples, the controller selects radio stations for the radio preset buttons based upon at least one of a language and the dialect of the voice command.

An example disclosed method includes storing acoustic models on memory of a vehicle and collecting, via a microphone, an audio signal that includes a voice command. The example disclosed method also includes identifying, via a controller, a dialect of the voice command by applying the audio signal to a deep neural network. The example disclosed method also includes downloading, via a communication module, a selected acoustic model for the dialect from a remote server upon determining the dialect does not correspond with any of the acoustic models.

Some examples further include retrieving the selected acoustic model from the memory upon determining that the acoustic models stored in the memory include the selected acoustic model. Some examples further include applying speech recognition to the audio signal utilizing the selected acoustic model to identify the voice command.

Some examples further include identifying a language of the voice command by applying the audio signal to the deep neural network and downloading, via the communication module, a selected language model for the language from a remote server upon determining that the language does not correspond with any language models stored in the memory of the vehicle. Some such examples further include retrieving the selected language model from the memory upon determining that the language models stored in the memory include the selected language model. Some such examples further include applying speech recognition to the audio signal utilizing the selected language model to identify the voice command.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a cabin of an example vehicle in accordance with the teachings herein.

FIG. 2 illustrates infotainment input and output devices of the vehicle in accordance with the teachings herein.

FIG. 3 is a block diagram of electronic components of the vehicle of FIG. 1.

FIG. 4 is a flowchart for obtaining acoustic and language models for speech recognition within a vehicle in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Typically, vehicles include a plurality of features and/or functions that are controlled by an operator (e.g., a driver). Oftentimes, a vehicle includes a plurality of input devices to enable the operator to control the vehicle features and/or functions. For instance, a vehicle may include button(s), control knob(s), instrument panel(s), touchscreen(s), and/or touchpad(s) that enable the operator to control the vehicle features and/or functions. Further, in some instances, a vehicle includes a communication platform that communicatively couples to mobile device(s) located within the vehicle to enable the operator and/or another occupant to interact with the vehicle features and/or functions via the mobile device(s).

Recently, some vehicles include microphone(s) that enable an operator located within a cabin of the vehicle to audibly interact with vehicle features and/or functions (e.g., via a digital personal assistant). For instance, such vehicles use a speech recognition system (e.g., including speech-recognition software) to identify a voice command of a user that is captured by the microphone(s). In such instances, the speech recognition system interprets the user's speech by converting phonemes of the voice command into actionable commands.

To facilitate use by a wide number of users, the speech recognition system may include a large number of grammar sets (for languages), language models (for languages), and acoustic models (for accents) to enable identification of a voice commands provided in a variety of languages and dialects. For instance, a plurality of acoustic models (e.g., North American English, British English, Australian English, Indian English, etc.) may exist for a single language. In some instances, the acoustic models, the language models, and the grammar databases take up a very large amount of storage space. In turn, because of the limited embedded storage capabilities within a vehicle, memory within the vehicle potentially may be unable to store the models and sets that correspond to every language and dialect of potential users. Further, in instances in which a user is unfamiliar with a default language and dialect of a vehicle, a user potentially may find it difficult to change vehicle settings from the default language and dialect to his or her native language and dialect.

Example methods and apparatus disclosed herein (1) utilize machine learning (e.g., a deep neural network) to identify a language and a dialect of a voice command provided by a user of a vehicle, (2) download a corresponding language model and a corresponding dialect acoustic model from a remote server to reduce an amount of vehicle memory dedicated to language and dialect acoustic models, and (3) performs speech recognition utilizing the downloaded language and dialect acoustic models to process the voice command of the user. Examples disclosed herein include a controller that receives a voice command from a user via a microphone of a vehicle. Based on the voice command, the controller identifies a language and a dialect that corresponds to the voice command. For example, the controller utilizes deep neural network model to identify the language and dialect corresponding to the voice command. Upon identifying the language and dialect of the voice command, the controller determines whether a corresponding language model and a corresponding dialect acoustic model is stored within memory of a computing platform of the vehicle. If the language model and/or the dialect acoustic model is not stored in the vehicle memory, the controller downloads the language model and/or the dialect acoustic model from a remote server and stores the downloaded language model and/or dialect acoustic model in the vehicle memory. Further, the controller utilizes the language model and the dialect acoustic model to perform speech recognition on the voice command. The vehicle provides requested information and/or performs a vehicle function based on the voice command. In some examples, the controller is configured to adjust default settings (e.g., a default language, radio settings, etc.) of the vehicle based on the identified language and dialect.

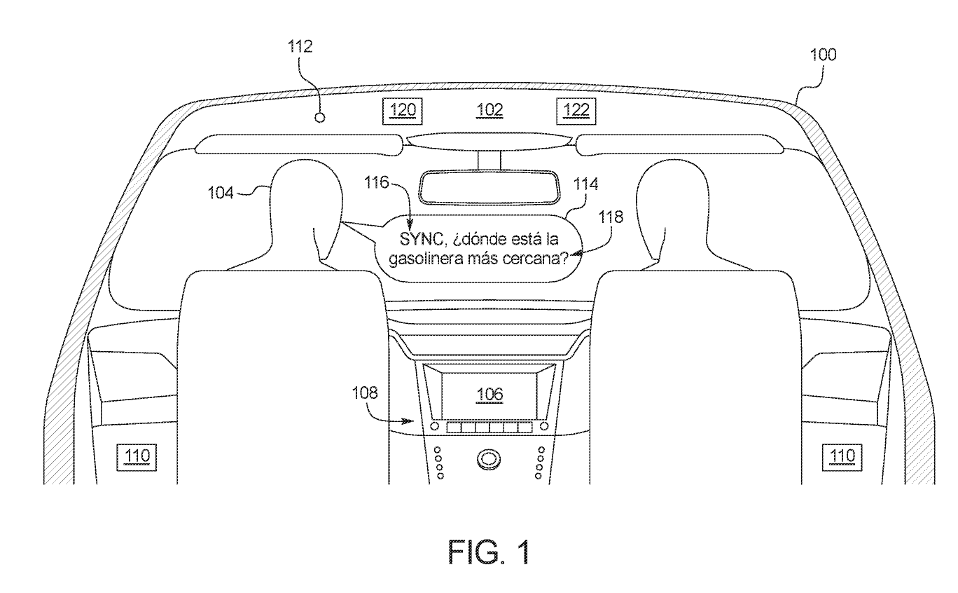

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example, the vehicle 100 includes a cabin 102 in which a user 104 (e.g., a vehicle operator, a driver, a passenger) is seated.

The vehicle 100 also includes a display 106 and preset buttons 108 (e.g., radio preset buttons). In the illustrated example, the display 106 is a center console display (e.g., a liquid crystal display (LCD), an organic light emitting diode (OLED) display, a flat panel display, a solid state display, etc.). In other examples, the display 106 is a heads-up display. Further, in the illustrated example, the preset buttons 108 include radio preset buttons. Additionally or alternatively, the preset buttons 108 include any other type of preset buttons (e.g., temperature preset buttons, lighting preset buttons, volume preset buttons, etc.).

Further, the vehicle 100 includes speakers 110 and a microphone 112. For example, the speakers 110 are audio output devices that emit audio signals (e.g., entertainment, instructions, and/or other information) to the user 104 and/or other occupant(s) of the vehicle 100. The microphone 112 is an audio input device that collects audio signals (e.g., voice commands, telephonic dialog, and/or other information) from the user 104 and/or other occupant(s) of the vehicle 100. In the illustrated example, the microphone 112 collects an audio signal 114 from the user 104. In other examples, a microphone of a mobile device of a user is configured to collect the audio signal 114 from the user 104. As illustrated in FIG. 1, the audio signal 114 includes a wake-up term 116 and a voice command 118. The user 104 provides the wake-up term 116 to indicate that the user 104 will subsequently provide the voice command 118. That is, the wake-up term 116 precedes the voice command 118 in the audio signal 114. The wake-up term 116 can be any word or phrase preselected by the manufacturer or the driver, such as an uncommon word (e.g., “SYNC”), an uncommon name (e.g., “Burton”), and/or an uncommon phrase (e.g., “Hey SYNC,” “Hey Burton”). Additionally, the voice command 118 includes a request for information and/or an instruction to perform a vehicle function.

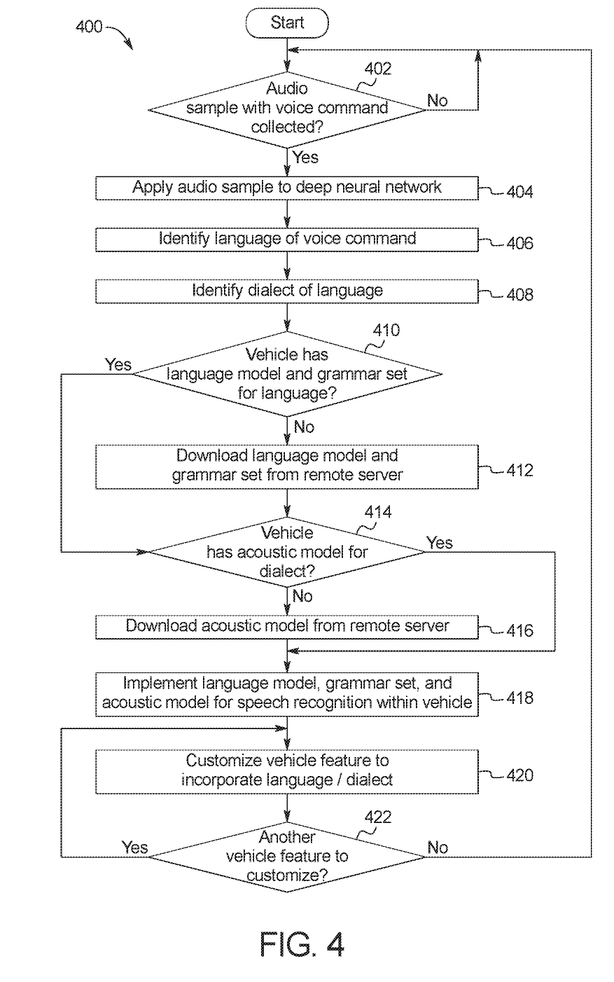

The vehicle 100 of the illustrated example also includes a communication module 120 that includes wired or wireless network interfaces to enable communication with external networks (e.g., a network 322 of FIG. 4). The communication module 120 also includes hardware (e.g., processors, memory, storage, antenna, etc.) and software to control the wired or wireless network interfaces. In the illustrated example, the communication module 120 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module 120 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle 100 may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

Further, the vehicle 100 includes a language controller 122 that is configured to perform speech recognition for audio signals (e.g., the audio signal) provided by users of the vehicle (e.g., the user 104). In operation, the language controller 122 collects the audio signal 114 via the microphone 112 and/or another microphone (e.g., a microphone of a mobile device of the user 104).

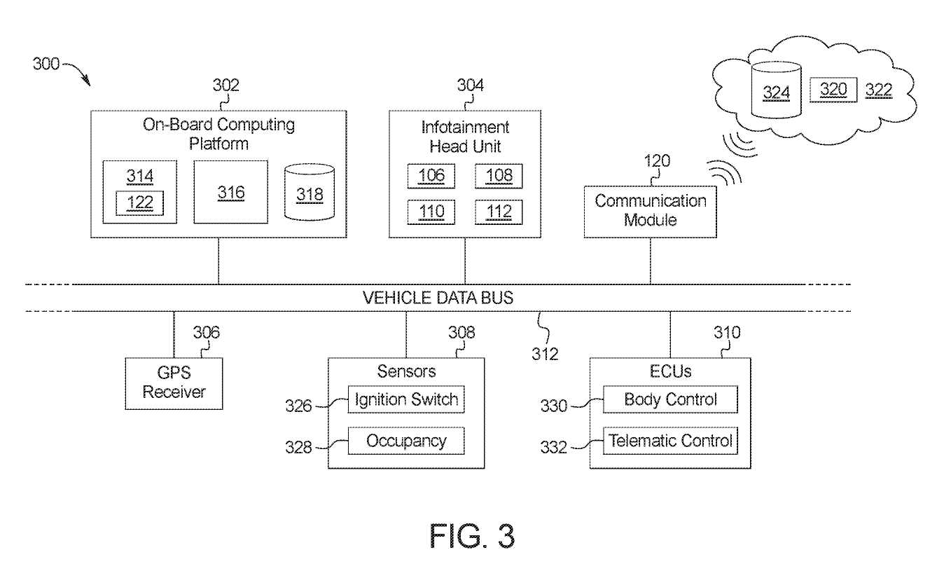

Upon collecting the audio signal 114, the language controller 122 is triggered to monitor for the voice command 118 upon detecting the wake-up term 116 within the audio signal 114. That is, the user 104 provides the wake-up term 116 to instruct the language controller 122 that the voice command 118 will subsequently be provided. For example, to identify the wake-up term 116, the language controller 122 utilizes speech recognition (e.g., via speech-recognition software) to identify a word or phrase within the audio signal and compares that word or phrase to a predefined wake-up term (e.g., stored in memory 316 and/or a database 318 of FIG. 3) that corresponds with the vehicle 100. Upon identifying that the audio signal 114 includes the wake-up term 116, the language controller 122 is triggered to detect a presence of the voice command 118 that follows the wake-up term 116.

Further, upon detecting the presence of the voice command 118, the language controller 122 identifies a language and a dialect of the voice command 118 by applying the wake-up term 116, the voice command 118, and/or any other speech of the audio signal 114 to a machine learning model. As used herein, a “language” refers to a system of communication between people (e.g., verbal communication, written communication, etc.) that utilizes words in a structured manner. Example languages include English, Spanish, German, etc. As used herein, a “dialect” refers to a variety or subclass of a language that includes characteristic(s) (e.g., accents, speech patterns, spellings, etc.) that are specific to a particular subgroup (e.g., a regional subgroup, a social class subgroup, a cultural subgroup, etc.) of users of the language. For example, each language corresponds to one or more dialects. Example dialects of the English language include British English, Cockney English, Scouse English, Scottish English, American English, Mid-Atlantic English, Appalachian English, Indian English, etc. Example Spanish dialects include Latin American Spanish, Caribbean Spanish, Rioplatense Spanish, Peninsular Spanish, etc.

Machine learning models are a form of artificial intelligence (AI) that enables a system to automatically learn and improve from experience without being explicitly programmed by a programmer for a particular function. For example, machine learning models access data and learn from the accessed data to improve performance of a particular function. In the illustrated example, a machine learning model is utilized to identify the language and the dialect of speech within the audio signal 114. For example, the language controller 122 applies the audio signal 114 to a deep neural network to identify the language and the dialect that corresponds with the audio signal 114. A deep neural network is a form of an artificial neural network that includes multiple hidden layers between an input layer (e.g., the audio signal 114) and an output layer (the identified language and the dialect). An artificial neural network is a type of machine learning model inspired by a biological neural network. For example, an artificial neural network includes a collection of nodes that are organized in layers to perform a particular function (e.g., to categorize an input). Each node is trained (e.g., in an unsupervised manner) to receive an input signal from a node of a previous layer and provide an output signal to a node of subsequent layer. For example, language controller 122 provides the audio signal 114 as an input layer to a deep neural network and receives a language and a dialect as an output layer based upon the analysis of each of the nodes within each of the layers of the deep neural network. Additionally or alternatively, the language controller 122 is configured to apply the audio signal to other machine learning model(s) (e.g., decision trees, support vectors, clustering, Bayesian networks, sparse dictionary learning, rules-based machine learning, etc.) to identify the language and the dialect corresponding with the audio signal 114.

Upon identifying the language and the dialect of the audio signal 114, the language controller 122 selects corresponding language and acoustic models. That is, the language controller 122 identifies a selected language model that corresponds with the identified language of the audio signal 114 and identifies a selected acoustic model that corresponds with the identified dialect of the audio signal 114. For example, upon identifying that the audio signal 114 corresponds with the Spanish language and the Peninsular Spanish dialect, the language controller 122 selects the Spanish language model and the Peninsular Spanish acoustic model. As used herein, a “language model” refers to an algorithm that is configured to identify one or more words within an audio sample by determining word probability distributions based upon one or more phonemes identified by an acoustic model. As used herein, an “acoustic model,” a “dialect model,” and a “dialect acoustic model” refer to an algorithm that is configured to identify one or more phonemes of a dialect within an audio sample to enable the identification of words within the audio sample. As used herein, a “phoneme” refers to a unique sound of speech.

Further, in response to identifying the selected language model and the selected acoustic model, the language controller 122 determines whether the selected language model and selected acoustic model are stored in memory of the vehicle 100 (e.g., memory 316 of FIG. 3). For example, the memory of the vehicle 100 stores language model(s), acoustic model(s), and/grammar set(s) to facilitate speech recognition of voice commands. In some examples, the memory of the vehicle 100 may be configured to store a limited number of language model(s), acoustic model(s), and/grammar set(s).

Upon determining that the language model(s) stored in the memory include the selected language model, the language controller 122 retrieves the selected language model and utilizes the selected language model for speech recognition within the vehicle 100. That is, the language controller 122 utilizes the selected language model for speech recognition when the memory of the vehicle 100 includes the selected language model. Otherwise, in response to determining that the selected language model does not correspond with any of the language model(s) stored in the memory of the vehicle 100, the language controller 122 downloads the selected language model from a remote server (e.g., a server 320 of FIG. 3) via the communication module 120 of the vehicle 100. In such examples, the language controller 122 stores the selected language model that was downloaded in the memory of the vehicle 100. Further, the language controller 122 utilizes the selected language model for speech recognition within the vehicle 100. Further, the memory of the vehicle 100 may include an insufficient amount of unused memory for downloading the selected language model. In some such examples, the language controller 122 is configured one of the language models and/or another model or file (e.g., the oldest language model, the least used language model, etc.) from the memory to create a sufficient amount of unused memory for downloading the selected language model.

Similarly, upon determining that the acoustic model(s) stored in the memory include the selected acoustic model, the language controller 122 retrieves the selected acoustic model and utilizes the selected acoustic model for speech recognition within the vehicle 100. That is, the language controller 122 utilizes the selected acoustic model for speech recognition when the memory of the vehicle 100 includes the selected acoustic model. Otherwise, in response to determining that the selected acoustic model does not correspond with any of the acoustic model(s) stored in the memory of the vehicle 100, the language controller 122 downloads the selected acoustic model from the remote server via the communication module 120 of the vehicle 100. In such examples, the language controller 122 stores the selected acoustic model that was downloaded in the memory of the vehicle 100. Further, the language controller 122 utilizes the selected acoustic model for speech recognition within the vehicle 100. In some examples, the memory of the vehicle 100 may include an insufficient amount of unused memory for downloading the selected acoustic model. In some such examples, the language controller 122 is configured one of the acoustic models and/or another model or file (e.g., the oldest acoustic model, the least used acoustic model, etc.) from the memory to create a sufficient amount of unused memory for downloading the selected acoustic model.

Further, the language controller 122 identifies the voice command 118 by utilizing the selected language and acoustic models to apply speech recognition (e.g., via speech-recognition software) to the audio signal 114. For example, the language controller 122 identifies that the voice command 118 includes a request for information and/or an instruction to perform a vehicle function. Example requested information includes directions to a desired location, information within an owner's manual of the vehicle 100 (e.g., a factory-recommended tire pressure), vehicle characteristics data (e.g., fuel level), and/or data stored in an external network (e.g., weather conditions). Example vehicle instructions include instructions to start a vehicle engine, lock and/or unlock vehicle doors, open and/or close vehicle windows, add an item to a to-do or grocery list, send a text message via the communication module 120, initiate a phone call, etc.

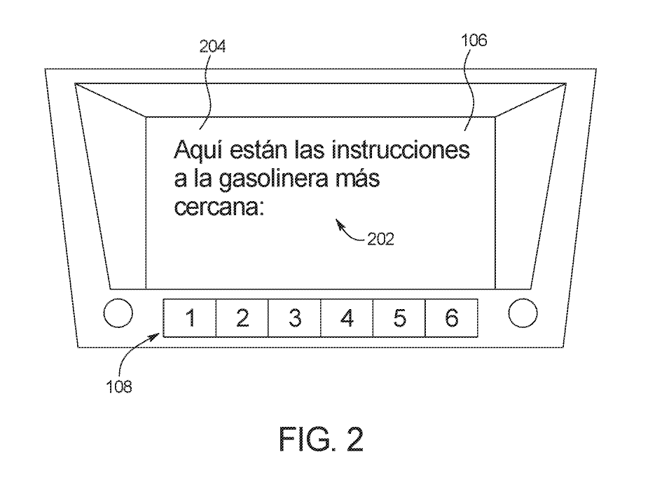

Additionally or alternatively, infotainment and/or other settings of the vehicle 100 may be updated to incorporate the identified language and dialect of the audio signal 114 provided by the user 104. FIG. 2 illustrates infotainment input and output devices of the vehicle 100 that are configured based upon the identified language and dialect of the audio signal 114. As illustrated in FIG. 2, the display 106 is configured to present text 202 in the language (e.g., the Spanish language) and the dialect (e.g., the Peninsular Spanish dialect) that correspond to the voice command 118 provided by the user 104 in response to the language controller 122 identifying the language and dialect of the voice command 118. In the illustrated example, the display 106 is a touchscreen 204 that is configured to present a digital keyboard. The language controller 122 is configured to select the digital keyboard for presentation based upon the language and/or the dialect of the voice command 118. Further, the preset buttons 108 of the illustrated example are radio preset buttons. The language controller 122 is configured to select radio stations for the preset buttons 108 based upon the language and/or the dialect of the voice command 118. Further, in some examples, the language controller 122 selects points-of-interest (e.g., local restaurants) based upon the language and/or the dialect of the voice command 118.

FIG. 3 is a block diagram of electronic components 300 of the vehicle 100. As illustrated in FIG. 3, the electronic components 300 include an on-board computing platform 302, an infotainment head unit 304, the communication module 120, a global positioning system (GPS) receiver 306, sensors 308, electronic control units (ECUs) 310, and a vehicle data bus 312.

The on-board computing platform 302 includes a microcontroller unit, controller or processor 314; memory 316; and a database 318. In some examples, the processor 314 of the on-board computing platform 302 is structured to include language controller 122. Alternatively, in some examples, the language controller 122 is incorporated into another electronic control unit (ECU) with its own processor 314, memory 316, and a database 318. Further, in some examples, the database 318 is configured to store language model(s), acoustic model(s), and/or grammar set(s) to facilitate retrieval by the language controller 122.

The processor 314 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 316 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 316 includes multiple kinds of memory, particularly volatile memory and non-volatile memory.

The memory 316 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 316, the computer readable medium, and/or within the processor 314 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 304 provides an interface between the vehicle 100 and the user 104. The infotainment head unit 304 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device such as the microphone 112, buttons such as the preset buttons 108, or a touchpad. The output devices may include instrument cluster outputs (e.g., dials, lighting devices), actuators, the display 106 (e.g., a center console display, a heads-up display, etc.), and/or the speakers 110. In the illustrated example, the infotainment head unit 304 includes hardware (e.g., a processor or controller, memory, storage, etc.) and software (e.g., an operating system, etc.) for an infotainment system (such as SYNC® and MyFord Touch® by Ford®). Additionally, the infotainment head unit 304 displays the infotainment system on, for example, the display 106.

The communication module 120 of the illustrated example is configured to wirelessly communicate with a server 320 of a network 322 to download language model(s), acoustic model(s), and/or grammar set(s). For example, in response to receiving a request from the language controller 122 via the communication module 120, the server 320 of the network 322 identifies the requested language model(s), acoustic model(s), and/or grammar set(s); retrieves the requested language model(s), acoustic model(s), and/or grammar set(s) from a database 324 of the network 322; and sends the retrieved language model(s), acoustic model(s), and/or grammar set(s) to the vehicle 100 via the communication module 120.

The GPS receiver 306 of the illustrated example receives a signal from a global positioning system to identify a location of the vehicle 100. In some examples, the language controller 122 is configured to change the selected language and/or dialect based upon the position of the vehicle 100. For example, the language controller 122 changes the selected language and/or dialect as the vehicle 100 leaves one region associated with a first language and/or dialect and enters another region associated with a second language and/or dialect.

The sensors 308 are arranged in and around the vehicle 100 to monitor properties of the vehicle 100 and/or an environment in which the vehicle 100 is located. One or more of the sensors 308 may be mounted to measure properties around an exterior of the vehicle 100. Additionally or alternatively, one or more of the sensors 308 may be mounted inside the cabin 102 of the vehicle 100 or in a body of the vehicle 100 (e.g., an engine compartment, wheel wells, etc.) to measure properties in an interior of the vehicle 100. For example, the sensors 308 include accelerometers, odometers, tachometers, pitch and yaw sensors, wheel speed sensors, microphones, tire pressure sensors, biometric sensors and/or sensors of any other suitable type.

In the illustrated example, the sensors 308 include an ignition switch sensor 326 and one or more occupancy sensors 328. For example, the ignition switch sensor 326 is configured to detect a position of an ignition switch (e.g., an on-position, an off-position, a start position, an accessories position). The occupancy sensors 328 are configured to detect when and/or at which position a person (e.g., the user 104) is seated within the cabin 102 of the vehicle 100. In some examples, the language controller 122 is configured to identify a language and/or dialect of a voice command upon determining that the ignition switch is in the on-position and/or the accessories position and one or more of the occupancy sensors 328 detects that a person is positioned within the cabin 102 of the vehicle 100.

The ECUs 310 monitor and control the subsystems of the vehicle 100. For example, the ECUs 310 are discrete sets of electronics that include their own circuit(s) (e.g., integrated circuits, microprocessors, memory, storage, etc.) and firmware, sensors, actuators, and/or mounting hardware. The ECUs 310 communicate and exchange information via a vehicle data bus (e.g., the vehicle data bus 312). Additionally, the ECUs 310 may communicate properties (e.g., status of the ECUs 310, sensor readings, control state, error and diagnostic codes, etc.) to and/or receive requests from each other. For example, the vehicle 100 may have dozens of the ECUs 310 that are positioned in various locations around the vehicle 100 and are communicatively coupled by the vehicle data bus 312.

In the illustrated example, the ECUs 310 include a body control module 330 and a telematic control unit 332. The body control module 330 controls one or more subsystems throughout the vehicle 100, such as power windows, power locks, an immobilizer system, power mirrors, etc. For example, the body control module 330 includes circuits that drive one or more of relays (e.g., to control wiper fluid, etc.), brushed direct current (DC) motors (e.g., to control power seats, power locks, power windows, wipers, etc.), stepper motors, LEDs, etc. Further, the telematic control unit 332 controls tracking of the vehicle 100, for example, utilizing data received by the GPS receiver 306 of the vehicle 100.

The vehicle data bus 312 communicatively couples the communication module 120, the on-board computing platform 302, the infotainment head unit 304, the GPS receiver 306, the sensors 308, and the ECUs 310. In some examples, the vehicle data bus 312 includes one or more data buses. The vehicle data bus 312 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

FIG. 4 is a flowchart of an example method 400 to obtain acoustic and language models for speech recognition within a vehicle. The flowchart of FIG. 4 is representative of machine readable instructions that are stored in memory (such as the memory 316 of FIG. 3) and include one or more programs which, when executed by a processor (such as the processor 314 of FIG. 3), cause the vehicle 100 to implement the example language controller 122 of FIGS. 1 and 3. While the example program is described with reference to the flowchart illustrated in FIG. 4, many other methods of implementing the example language controller 122 may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below.

Initially, at block 402, the language controller 122 determines whether an audio sample (e.g., the audio signal 114) with a voice command (e.g., the voice command 118) is collected via the microphone 112. In response to the language controller 122 determining that an audio sample with a voice command has not been collected, the method 400 remains at block 402. Otherwise, in response to the language controller 122 determining that the audio signal 114 with the voice command 118 has been collected, the method 400 proceeds to block 404.

At block 404, the language controller 122 applies the audio signal 114 to a deep neural network and/or another machine learning model. At block 406, the language controller 122 identifies a language of the voice command 118 based upon the application of the audio signal 114 to the deep neural network and/or other machine learning model. At block 408, the language controller 122 identifies a dialect of language identified at block 406 based upon the application of the audio signal 114 114 to the deep neural network and/or other machine learning model.

At block 410, the language controller 122 determines whether the memory 316 of the on-board computing platform 302 of the vehicle 100 includes a language model and a grammar set that corresponds with the identified language. In response to determining that the memory 316 of the vehicle includes the language model and the grammar set, the method 400 proceeds to block 414. Otherwise, in response to determining that the memory 316 of the vehicle does not include the language model and the grammar set, the method 400 proceeds to block 412 at which the language controller 122 downloads the language model and the grammar set from the server 320 via the communication module 120 of the vehicle 100. Further, the language controller 122 stores the downloaded language model and grammar set in the memory 316 of the vehicle 100.

At block 414, the language controller 122 determines whether the memory 316 of the on-board computing platform 302 of the vehicle 100 includes an acoustic model that corresponds with the identified dialect. In response to determining that the memory 316 of the vehicle includes the acoustic model, the method 400 proceeds to block 418. Otherwise, in response to determining that the memory 316 of the vehicle does not include the acoustic model, the method 400 proceeds to block 416 at which the language controller 122 downloads the acoustic model from the server 320 via the communication module 120 of the vehicle 100. Further, the language controller 122 stores the downloaded acoustic model in the memory 316 of the vehicle 100.

At block 418, the language controller 122 implements the identified language model, acoustic model, and grammar set for speech recognition within the vehicle 100. For example, the language controller 122 performs speech recognition utilizing the identified language model, acoustic model, and grammar set to identify the voice command 118 within the audio signal 114. Upon identifying the voice command 118, the language controller 122 provides information to the user 104 and/performs a vehicle function based on the voice command 118.

At block 420, the language controller 122 customizes a vehicle feature (e.g., the text 202 presented via the display 106, radio settings for the preset buttons 108, etc.) based upon the identified language and/or dialect. At block 422, the language controller 122 determines whether there is another vehicle feature to customize for the user 104. In response to the language controller 122 determining that there is another vehicle feature to customize, the method 400 returns to block 420. Otherwise, in response to the language controller 122 determining that there is not another vehicle feature to customize, the method 400 returns to block 402.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module,” “unit,” and “node” refer to hardware with circuitry to provide communication, control and/or monitoring capabilities, often in conjunction with sensors. A “module,” a “unit,” and a “node” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a microphone;
a communication module; and
memory storing acoustic models for speech recognition;
a controller to:
collect an audio signal that includes a voice command;
identify a dialect of the voice command by applying the audio signal to a deep neural network; and
download, upon determining the dialect does not correspond with any of the acoustic models, a selected acoustic model for the dialect from a remote server via the communication module.

2. The vehicle of claim 1, wherein the selected acoustic model includes an algorithm that is configured to identify one or more phonemes of the dialect within the audio signal, the one or more phonemes are unique sounds of speech.

3. The vehicle of claim 1, wherein, upon the controller downloading the selected acoustic model from the remote server, the memory is configured to store the selected acoustic model and the controller is configured to utilize the selected acoustic model for the speech recognition.

4. The vehicle of claim 1, wherein the controller is to retrieve the selected acoustic model from the memory upon determining that the acoustic models stored in the memory include the selected acoustic model.

5. The vehicle of claim 1, wherein, to identify the voice command, the controller applies the speech recognition to the audio signal utilizing the selected acoustic model.

6. The vehicle of claim 1, wherein the memory further stores language models for the speech recognition.

7. The vehicle of claim 6, wherein the controller is to:
identify a language of the voice command by applying the audio signal to the deep neural network; and
download, upon determining that the language does not correspond with any of the language models store in the memory, a selected language model for the language from the remote server via the communication module.

8. The vehicle of claim 7, wherein, upon the controller downloading the selected language model from the remote server, the memory is configured to store the selected language model and the controller is configured to utilize the selected language model for the speech recognition.

9. The vehicle of claim 7, wherein the controller is to retrieve the selected language model from the memory upon determining that the language models stored in the memory include the selected language model.

10. The vehicle of claim 1, wherein a selected language model includes an algorithm that is configured to identify one or more words within the audio signal by determining word probability distributions based on or more phonemes identified by the selected acoustic model.

11. The vehicle of claim 1, wherein, to identify the voice command, the controller applies the speech recognition to the audio signal utilizing a selected language model.

12. The vehicle of claim 1, further including a display that presents information in at least one of a language and the dialect of the voice command upon the controller identifying the language and the dialect of the voice command.

13. The vehicle of claim 12, wherein the display includes a touchscreen that is configured to present a digital keyboard, the controller selects the digital keyboard based upon at least one of the language and the dialect of the voice command.

14. The vehicle of claim 1, further including radio preset buttons, wherein the controller selects radio stations for the radio preset buttons based upon at least one of a language and the dialect of the voice command.

15. A method comprising:
storing acoustic models on memory of a vehicle;
collecting, via a microphone, an audio signal that includes a voice command;
identifying, via a controller, a dialect of the voice command by applying the audio signal to a deep neural network; and
downloading, via a communication module, a selected acoustic model for the dialect from a remote server upon determining the dialect does not correspond with any of the acoustic models.

16. The method of claim 15, further including retrieving the selected acoustic model from the memory upon determining that the acoustic models stored in the memory include the selected acoustic model.

17. The method of claim 15, further including applying speech recognition to the audio signal utilizing the selected acoustic model to identify the voice command.

18. The method of claim 15, further including:
identifying a language of the voice command by applying the audio signal to the deep neural network; and
downloading, via the communication module, a selected language model for the language from a remote server upon determining that the language does not correspond with any language models stored in the memory of the vehicle.

19. The method of claim 18, further including retrieving the selected language model from the memory upon determining that the language models stored in the memory include the selected language model.

20. The vehicle of claim 18, further including applying speech recognition to the audio signal utilizing the selected language model to identify the voice command.
